(19) United States
(12) Patent Application Publication
(10) Pub. No.: US 2026/0288655 A1
(43) Pub. Date: Sep. 24, 2026

(54) SYSTEM AND METHOD TO PREVENT UNAUTHORIZED MEMORY ACCESS

(71) Applicant: Keeper Security, Inc., Chicago, IL (US)

(72) Inventors: Craig B. Lurey, El Dorado Hills, CA (US); Arlen Yan, Elk Grove, CA (US)

(21) Appl. No.: 19/082,841

(22) Filed: Mar. 18, 2025

(51) Int. Cl. G06F 12/14; G06F 21/54

(52) U.S. Cl. CPC G06F 12/1441; G06F 12/1483; G06F 21/54

(57) ABSTRACT

A system and method for controlling access by a requesting process to a region of memory associated with a target process operating on a computer-based device. A request from the requesting process for a reference to the region of memory is intercepted, the reference is received, and whether the requesting process is authorized to access the region of memory is determined. The received reference is provided to the requesting process if the requesting process is authorized. A modified reference is developed and the modified reference is provided to the requesting process instead of the received reference if the requesting process is not authorized. The modified reference prevents the requesting process from accessing the region.

### FIELD OF DISCLOSURE

The present subject matter relates to systems and methods for preventing unauthorized access to memory and more particularly, system and methods that prevent one process from accessing memory used by another process.

### BACKGROUND

An application program on a computer, e.g., a password manager, web browser, security tool, and the like may store and manage sensitive data such as passwords, cryptographic keys, account numbers, and the like. Such data may be saved in one or more files, databases, and the like in an encrypted form until the data is used by a process associated with the application program. As used herein, an application program generally refers to the executable instructions stored on a memory device of the computer that upon execution generates or instantiates one or more processes that operate on the computer and are managed by an operating system of the computer. When a process is operating on the computer, a copy of the sensitive data used thereby may be loaded (i.e., read or copied) into a portion of memory (“application memory”) of the computer allocated to the process by the operating system. In some cases, the process may decrypt the encrypted data associated with the sensitive data into clear-text when such data is loaded into the application memory. In addition, the process may develop or receive additional sensitive data (e.g., session tokens, decryption keys, account numbers, private user information, and the like) from other processes during execution and store such additional sensitive data in the application memory. In some cases, the operating system of the computer may provide a facility (e.g., a system call) that may be used by a requesting process operating on the computer to request access to and read the application memory (including sensitive data) of a target process. In particular, the operating system may provide to the requesting process a handle (i.e., a data structure having a pointer, memory address, and the like) associated with the application memory of the target process. The requesting process may then use such handle to obtain the contents of the application memory associated with the handle (and the target process). The requesting process may be associated with, for example, by an application program such as a debugger application, a security tool (e.g., for virus or malware detection, etc.), and the like that monitors operation of processes operating on the computer. However, the requesting process may be associated with a malware application from a malicious actor that requests the handle to the application memory of the target process in order to obtain the sensitive information stored in such application memory for nefarious purposes of the malicious actor.

### SUMMARY

According to one aspect, a system for controlling access by a requesting process to a region of memory associated with a target process operating on a computer-based device includes a procedure having executable instructions that causes the computer-based device to intercept a request for a reference to the region of memory from the requesting process, receive the reference, and determine if the requesting process is authorized to access the region of memory. The procedure further causes the computer-based device to provide the received reference to the requesting process if the requesting process is authorized, and develop a modified reference and provide the modified reference to the requesting process instead of the received reference if the requesting process is not authorized. The modified reference prevents the requesting process from accessing the region.

According to another aspect, a method for controlling access by a requesting process to a region of memory associated with a target process includes intercepting an operating system request for a reference to the region of memory from a requesting process, receiving the reference, and determining if the requesting process is an authorized process allowed access to the region of memory. The method further includes providing the received reference to the requesting process if the requesting process is authorized and developing a modified reference and providing the modified reference instead of the received reference to the requesting process if the requesting process is not authorized. The modified reference prevents the requesting process from accessing the region.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a schematic diagram of a computer-based device in accordance with the present disclosure;

FIG. 2 is a schematic diagram of a memory protection system of the computer-based device of the FIG. 1;

FIG. 3 is a schematic diagram of a memory of the computer-based device of FIG. 1;

FIG. 4 is a process diagram showing steps undertaken by the memory protection system of FIG. 2 to selectively control access to the memory of FIG. 3;

FIG. 5 illustrates a graphical user interface of the memory protection system of FIG. 2;

FIG. 6 is a data flow diagram showing interactions between a requesting process, an operating system, and the memory protection system of FIG. 2;

FIG. 7 is a data flow diagram showing further interactions between the requesting process and the operating system of FIG. 6;

FIG. 8 is a process diagram showing steps undertaken by the memory protection system of FIG. 2 to determine whether to provide access to the memory of FIG. 3; and

FIG. 9 is a process diagram showing steps undertaken by the memory protection system of FIG. 2 to stop control of access to the memory of FIG. 3.

### DETAILED DESCRIPTION

Described herein is a memory protection system (MPS) operating on a computer-based device that controls limits access to application memory of a first process operating on the computer by a second process. An operating system such as, for example, Windows, the Macintosh Operating System (MacOS), Unix, Linux, and the like controls and manages functions of the computer-based device and operation of processes (e.g., the first process and the second process) thereon. The MPS allows a user to selectively activate the protection features of the MPS and, in response, the MPS installs and registers with the operating system a callback procedure (i.e., a kernel-level driver, a kernel extension, and the like), and configures the operating system to invoke the callback procedure whenever a requesting process requests access to the application memory of a target process. The operating system may be configured to provide to the callback procedure information that may be used to identify a first application program associated with the requesting process, information that may be used to identify a second application program associated with the target process, and a reference such as a handle to the application memory of the target process requested by the requesting process. The callback procedure checks if the first application program and the second application program are identical and, if so, causes the operating system to provide the handle to the requesting process. Otherwise, the callback procedure determines if the target process is associated with a protected application program (i.e., a program such as a web browser, a banking application, and the like that may have sensitive information stored in the memory allocated thereto). If the target process is not associated with a protected application program, the callback procedure again causes the operating system to provide the handle to the requesting process. The callback procedure also determines if the requesting process is a predetermined legitimate process, for example, a process associated with the operating system that is known to require access to the memory of other process, and if so, causes the operating system to provide the handle to the requesting process.

If the first application program and the second application program are not identical, the target process is associated with a predetermined protected application, and the requesting process is not a process associated with the operating system that requires access, the callback procedure modifies the handle and causes the operating system to provide the modified to the requesting process. The modified handle is modified so that the requesting process cannot use the modified handle provided thereto by the operating system to access memory associated with the modified handle (and thus the memory associated with the target process). In some cases, the handle has access rights encoded therein or otherwise associated therewith that the operating system is configured to check each time the handle is used to access memory referenced by the handle and the callback procedure modifies such access rights (e.g., by turning off read access) to prevent the handle from being used to read the application memory referenced thereby. In other embodiments, the callback procedure may cause operating system to provide a modified handle that references an invalid memory location, generates an error condition, and the like to the requesting process instead of the valid handle associated with the memory of the target process. In some embodiments, the MPS may allow the user to deactivate use of the MPS and in response the MPS unloads and unregisters the callback procedure from the operating system and releases any system resources allocated by the callback procedure.

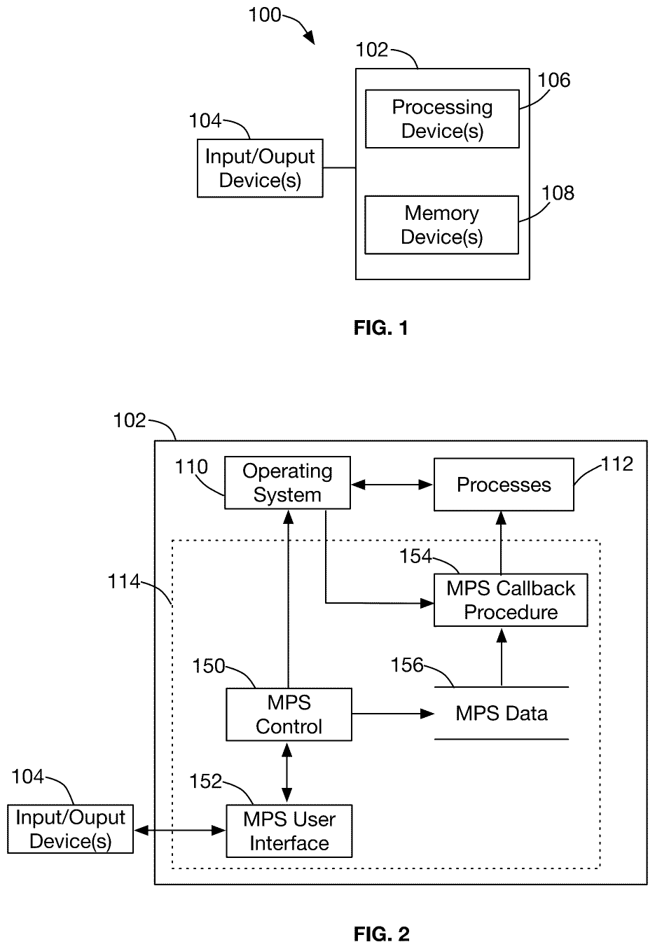

Referring to FIGS. 1 and 2, a computer system 100 on which the MPS may operate includes a suitably programmed computer-based device 102 and one or more input/output device(s) 104. The computer-based device 102 includes one or more processing device(s) 106 and one or more memory device(s) 108 The one or more memory device(s) 108 have stored therein, among other things, one or more application programs comprising programming instructions executed by one or more processing device(s) 106 to cause the computer system 100 to undertake certain operations.

Each processing device 106 may comprise, e.g., a processor or computer, a device using one or more application specific integrated circuits (ASIC's), field-programmable gate arrays (FPGA's), and/or combinations thereof. The input/output devices 104 may include one or more of a keyboard, a mouse, a display, a touchscreen, a joystick, etc. via which an operator may monitor and direct operation of the computer system 100. In addition, the input/output devices 104 may comprise communication devices that allow the computer system 100 to communicate with other computer systems using a local area network (LAN), a wide-area network (WAN), a cellular network, and others networking technologies apparent to one who has ordinary skill in the art.

Referring also to FIG. 2, an operating system 110, one or more processes 112, and the MPS 114 operate on the computer-based device 102. The operating system 110 includes executable instructions that cause the processing device(s) 106 to load and execute instructions associated with one or more process(es) 112 and the MPS 114 to undertake various operations of the computer system 100. As should be apparent to one who has ordinary skill in the art, the operating system 100 provides and manages various services used by the processes 112 and the MPS 114 operating on the computer system 100 including communications with a user or another computer-based device using the input/output devices 104, communications between the processes 112 and the MPS 114, and the like. The processes 112 and the MPS 114 are typically instantiated when the operating system 110 directs the processing device 106 to load and begin execution of an application program (or portion thereof) stored in the memory device(s) 108. Execution application program may cause an instance of a single process 112 or a instances of a plurality of processes 112 associated with the application program.

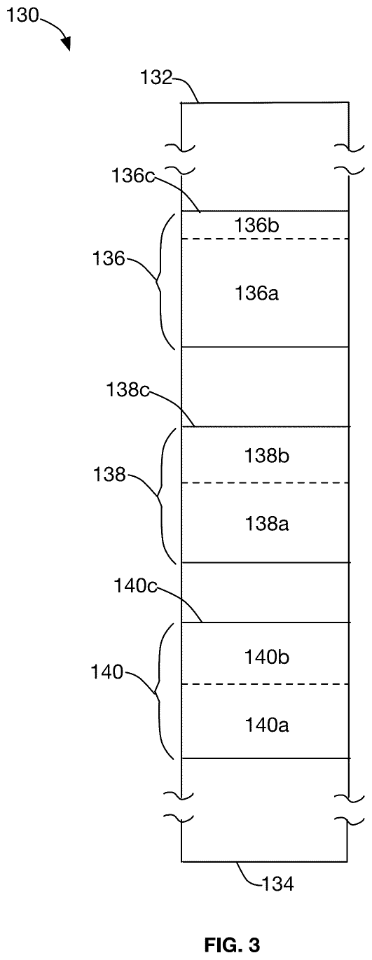

Referring also to FIG. 3, the operating system 110 also provides memory management services that allocate regions of a memory 130 to processes associated with the operating system 110, the processes 112, and processes associated with the MPS 114. The memory 130 comprises a plurality of contiguous addressable locations wherein each location is associated with a memory address that is between a base address 132 and a maximum address 134. The memory 130 may correspond to addressable locations of a combination of physical memory provided by the one or more memory devices 108. Resolution of an address location in the memory 130 to an address in a particular physical memory device 108 is coordinated by the memory management services provided by the operating system 110 in combination with a controller (not shown) associated with the one or more memory devices 108.

As shown in FIG. 3, for example, a first contiguous region 136 of the memory 130 may be allocated to a first process associated with the operating system 110 and executable instructions associated with the first process may be loaded in a sub-region 136a and data used by the first process may be stored in a sub-region 136b. Similarly, a second contiguous region 138 of the memory 130 may be associated with a second process that may be one of the processes 112 and executable instructions for the second process may be loaded in the sub-region 138a and data used by the second process may be stored in the sub-region 138b. Execution of the MPS 114 also instantiates one or more processes and a third process associated with the MPS 114 may be allocated a region 140 of the memory 130, wherein executable instructions of the third process are loaded in the sub-region 140a and data used by the third process are stored in the sub-region 140b. A requesting process operating on the computer-based device 102 and loaded in the memory 130 may request from the operating system 110 access to read (and possibly write) to the memory locations allocated to with, for example, one of the first, second, or third processes loaded in the regions 136, 138, and 140, respectively, of the memory 130. In response, the operating system 110 may return a data structure (i.e., a handle), for example having a Windows “Handle” data type, that is associated with the contiguous region 136, 138, or 140 to the requesting process. The requesting process use the handle provided by the operating system to access (i.e., read and/or write) data stored in the region 136, 138 or 140 (and more particularly the regions 136b, 138b, and 140b in which data associated with the first, second, and third processes, respectively, is stored). In some embodiments, the requesting process may supply information identifying a target process as a parameter a first system call provided by the operating system to obtain the handle and then supply the handle as a parameter to a second system call provided by the operating system to retrieve and/or duplicate consecutive bytes stored at the memory address of the memory 130 associated with the handle and at a specified number of contiguous memory locations following such memory address. In some embodiments, the data structure that encodes the handle includes an indicator of a permission associated with the contents of the memory 130 at the memory address associated with the handle. Such permission may indicate that the contents may be read and/or written to by a process having administrator privileges, a process having user (i.e., non-administrator) privileges, or no process may read/write such contents. In some embodiments, whether the requesting process has user privileges or administrator privileges may be specified when the process is instantiated. Typically, the operating system 110 provides a handle having permissions that allow a process having user level or administrator level privileges to read the contents of the locations of the memory 130 associated with the handle. As described in greater detail below, the MPS 114 augments the typical memory management services provided by the operating system 110 to further restrict access to the memory 130.

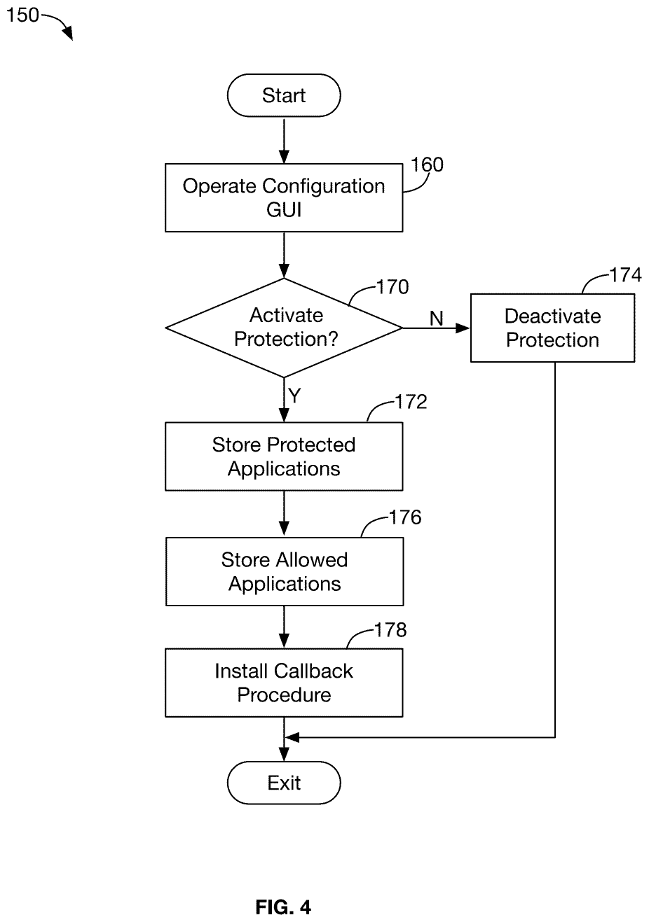

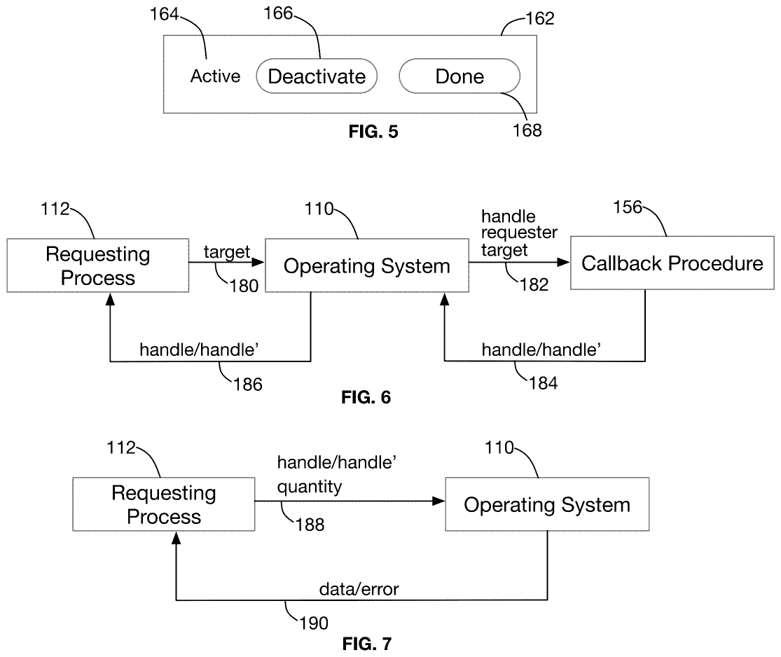

Referring once again to FIG. 2, the MPS 114 includes an MPS control process 150, an MPS user interface process 152, an MPS callback procedure 154, and an MPS data store 156. FIG. 4 shows the steps undertaken by the MPS control process 150 when the user directs the operating system 110 to launch an application program associated with the MPS 114. At step 160, the MPS control process 150 directs the MPS user interface process 152 to generate a graphical user interface (GUI) 162 (FIG. 5) on a display comprising the input/output devices 104. The GUI 162 allows the user to specify whether memory access protection afforded by the MPS 114 should be active or inactive. Referring also to FIG. 5, the GUI 162 may include, for example, a dialog box that has an indicator 164 that informs the user whether the memory protection provided by the MPS 114 is currently active or inactive, a selector (e.g., a button or a check box) 166 that allows the user to change the memory protection provided by the MPS 114 from currently active to inactive or from currently inactive to active, and a selector 168 that allows the user to close the dialog box associated with the GUI 162 without modifying current memory protection provided by the MPS 114. Selecting the selector 166 or 168 causes the MPS user interface process 152 to close the dialog box of the GUI 162 and return a value to the MPS control process 150 that indicates whether the user indicated the memory protection provided by the MPS 114 should be active or inactive.

Thereafter, the MPS control process 150, at step 170 determines whether the user indicated that the memory access protection provided by the MPS 114 should be active and, if so, proceeds to step 172. Otherwise, at step 174, MPS control process 150 deactivates memory protection as described in greater detail below and exits.

At step 172, the MPS control process 150 develops identifying information associated with protected applications whose application memory should not be accessed by a requesting process unless the requesting process is associated with a predetermined allowed application or is an operating system process that requires such access. In some embodiments, the names of the protected application programs and/or processes associated therewith are stored in a configuration file associated with the MPS 114. In such embodiments, for each such named application program and/or process, the MPS control process 150, at step 172, determines if an executable file associated with the named application program and/or process is installed in a predetermined location where the operating system stores such executable files and develops a fully resolved file path to such executable file as part of the identifying information. In some embodiments, the configuration file having the names of protected application programs and/or processes may be modified by an authorized user to identify additional protected application programs and/or processes associated with regions of the memory 130 that is protected by the MPS 114 modify the configuration file to remove names one or more protected application programs and/or processes. The MPS control process 150 stores the identifying information developed at step 172 in the MPS data store 156.

At step 174 develops identifying information associated with requesting processes that are authorized to access regions of the memory 130 associated with the protected applications determined at step 172 and stores such identifying information in the MPS data store 156. Such authorized requesting process may be associated with, for example, an operating system process that requires access to memory of other processes such as, for example, the Client/Server Runtime System (associated with the application program “csrss.exe”) of the Windows operating system, and the like. In some embodiments, a configuration file may identify the application programs and/or requesting processes that are allowed to access the regions of the memory 130 associated with processes 112 of other application programs and/or processes. The MPS control process 150, also at 174, develops a fully resolved path to the application program files associated with each allowed application program as part of the identifying information associated therewith. Further, the configuration file having the names of the application program files and/or processes allowed to access the regions of the memory 130 of other processes 112 may be modified by the authorized user as discussed above. Further, in some embodiments, one configuration file includes the names of the protected application programs and/or processes and the names of the allowed application programs and/or processes.

As discussed above, the identifying information for the protected applications and for the allowed requesting application developed at steps 172 and 174 may include the fully resolved file path to an application program file having executable instructions for such application program and/or process. Any file path shorteners such as variable names associated with partial paths (e.g., “%SystemRoot%,” and the like), aliases, and/or symbolic links represented in the file path are fully resolved so that the fully resolved file path specifies all of the folders or directories that must be traversed to locate the application file. It should be apparent to one who has ordinary skill in the art that fully resolving the file path in this manner correctly identifies the particular applications program file associated with each protected application program/process and allowed application program/process even in environments having complex directly structures. Further, using fully resolved paths may prevent a malicious application program masquerading as an application program that is allowed to access the memory of other process from being inadvertently granted such access simply because the malicious application program and a legitimate application program have an identical partial path and/or application file name.

At step 178, the MPS control process 150 directs the operating system 110 to install and load the MPS callback procedure 154 as a kernel-level driver including, for example, a kernel extension, a daemon, a service agent etc., that is invoked by the operating system each time a process 112 requests a handle to the region of the memory 130 associated with another process 112. Further, in some embodiments, the MPS control process 150 configures the operating system 110 to load the MPS callback procedure 154 each time the operating system 110 is started or restarted. In some embodiments, the MPS control process 150 copies a file containing executable instructions associated with the callback procedure 154 to a predetermined directory in which kernel level drivers are stored and uses a system call provided by the operating system 110 to load the callback procedure 154. Other ways of configuring the operating system 110 to install and load the MPS callback procedure 154 in accordance with the features of the operating system 110 apparent to one who has ordinary skill in the art may be used in other embodiments.

After the MPS callback procedure 154 is installed and loaded at step 178, the MPS control process 150 exits.

FIG. 6 is a dataflow diagram that illustrates the interaction between a requesting process 112, the operating system 110, and MPS callback procedure 154 when the requesting process 112 issues a system call to request a handle to a region of the memory 130. In particular, the requesting process 112 that wishes to access a region of the memory 130 associated with a target process creates and sends the request for such access that identifies the target process (arrow 180). The target process may be identified in the request, for example, by a process id (PID) value, a process name, an application name, and the like. The operating system 110 determines the start of the region of the memory 130 associated with the target process and creates a handle that may be used to access such region. The operating system 110 then invokes the callback procedure 154 and provides the callback procedure 154 parameters that include the handle created by the operating system 110 and identification information associated the requesting process 112 and the target process (arrow 182). The callback procedure 154 determines if the requesting process 112 is authorized to access the region of memory associated with the handle and if so returns the handle supplied by the operating system back to the operating system 110 (arrow 184). Otherwise, the callback procedure 154 modifies the handle and returns the modified handle (handle′) to the operating system (also arrow 184). The operating system 110 forwards the handle or modified handle supplied by the callback procedure 154 to the requesting process 112 (arrow 186).

FIG. 7 is a dataflow diagram that illustrates how the requesting process 112 accesses the region of memory 130 associated with the handle. The requesting process 112 creates and sends to the operating system 110 a request (e.g., a system call) that includes the handle to a region of the memory 130 (e.g., the handle or modified handle received from the operating system 110 in accordance with FIG. 6) and a quantity of bytes to retrieve beginning at an address location of the memory 130 represented by the supplied handle (arrow 188). The operating system 110 determines if the handle provided with the requesting process 112 indicates the requesting process is associated with a legitimate memory address and any permissions associated with the handle indicate the requesting process 112 is authorized to access the contents of the memory 130 associated with such memory address. If so (i.e., the handle supplied by the requesting procedure is not a modified handle), the operating system 110 returns the data comprising the requested quantity of bytes stored in the memory location associated with the handle. Otherwise, the operating system 110 returns an indication to the requesting process that an error occurred (i.e. the request is denied and access to the region of the memory 130 is prevented).

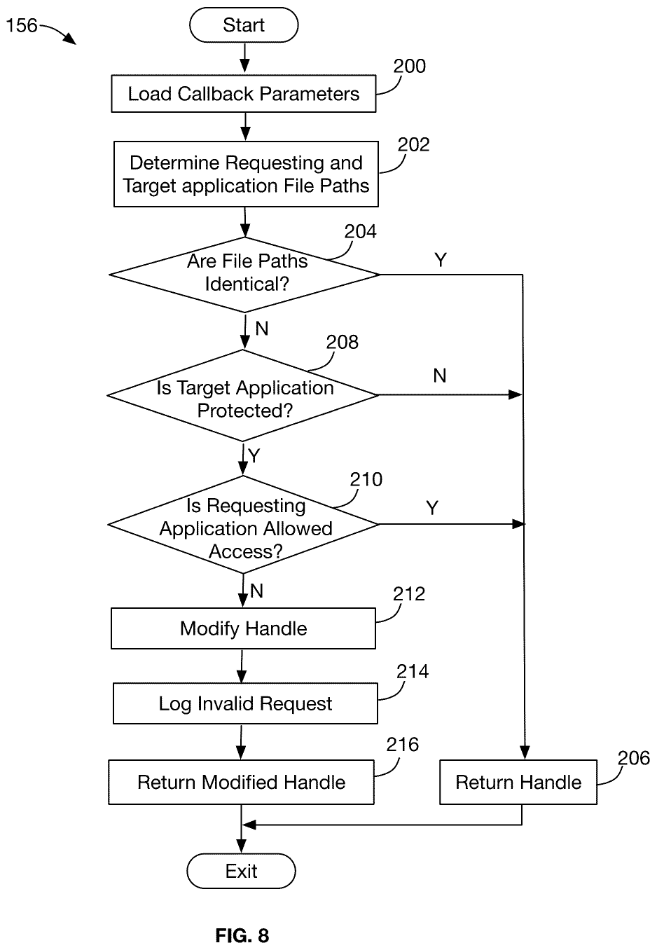

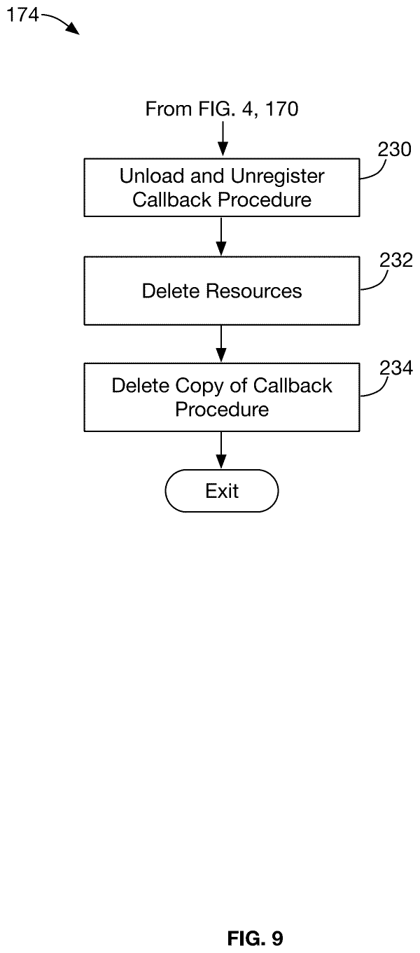

FIG. 8 is flowchart of steps undertaken by the callback procedure 154 when invoked by the operating system 110 in response to a request from the requesting process 112. At step 200, the callback procedure 15 loads the parameters supplied by the operating system 110 including identifying information of the requesting process 112, identifying information of the target process 112, and the handle to the region of the memory 130 the operating system 110 has determined is associated with the target process 112. At step 202, the callback procedure 154 develops first and second fully resolved file paths of the application programs associated with each of the requesting process 112 and the target process 112, respectively. As discussed above, the first and second fully resolved file path identify each folder or directory that must be traversed to locate the file having executable instructions associated with the application programs associated with the requesting process 112 and target process 112, respectively.

At step 204, the callback procedure 154 determines if the first fully resolved file path of the application program associated with the requesting process and the second fully resolved file path of the application program associated with the target process are identical and, if so, proceeds to step 206. At step 206, the callback procedure 154 returns the handle loaded at step 200 to the operating system 110 thereby causing such handle to be returned to the requesting process 112, and exits.

If the first fully resolved file path and the second fully resolved file path are not determined to be identical at step 202, the callback procedure 154, at step 208, determines if the second fully resolved file path associated with the target process is identical to a fully resolved file path stored in the MPS data store 156 at step 172 (FIG. 4) associated with a protected application program. If the fully resolved file path is not associated with a protected application program, the callback procedure 154 proceeds to step 206.

Otherwise, at step 210, the callback procedure 154 determines if the first fully resolved file path of the application program associated with the requesting application is identical to a fully resolved file path stored in the MPS data store 156 that is associated with an application program that is always authorized to access regions of the memory 130 of other processes 112. If so, the callback procedure 154 proceeds to step 206. Otherwise, the callback procedure 154, at step 212 modifies the handle loaded at step 200 as discussed above to indicate the requesting process 112 is denied access to the region of the memory 130 associated with the target process 112. As noted above, the callback procedure 154 may modify permissions associated with the handle to deny read access to such region, may modify the address location indicated in the handle, and the like. For example, if the operating system 110 is Windows, the callback procedure 154 removes the “PROCESS_VM_READ” permission from the permissions associated with handle. The callback procedure 154, at step 214, generates and records an entry in a system logfile or a logfile associated with the MPS 114 stored in the one or more memory devices 108 that an unauthorized attempt to access the memory of the target process 112 was made and denied by the MPS 114. Such log entry may identify, for example, the requesting process 112 and/or application program, the target process 112 and/or application program, a timestamp, the user associated with the requesting process 112, and the like. Such log entries generated by the callback procedure 154 may be analyzed during, for example, a security audit or scan to identify processes and/application programs that are attempting to improperly access regions of the memory 130. Thereafter, at step 216, callback procedure 154 returns the modified handle to the operating system 110 thereby causing the operating system 110 to return the modified handle to the requesting process 112, and exits. It should be apparent the creating the log entry at step 214 may be optional in some embodiments of the MPS 114 and processing proceeds from step 212 to step 216 in such embodiments.

In some embodiments, the callback procedure 154, at steps 204 and/or 210, may perform one or more additional security check(s) on the application program associated with the requesting process 112 such as, for example, checking a signature associated with such application program to confirm the signature resolves to a valid security certificate, and the like, and may proceed to step 206 and return the handle only if such one or more security check(s) are passed.

FIG. 8 shows steps undertaken by the MPS control process 150 when to deactivate memory protection at step 174 of FIG. 4. Referring to FIG. 8, at step 230, the MPS control process 150 uses one or more system call(s) provided by the operating system 110 to unload and unregister the callback procedure 154 as a kernel-level driver. At step 232, MPS control process 150 deletes any resources (e.g., memory, files, etc.) allocated by the callback procedure 154. At step 234, the MPS process 150 deletes any copy of the file containing executable instructions associated with the callback procedure 154 created when the callback procedure 154 was installed (i.e., at step 178, FIG. 4). Thereafter, the MPS control process 150 exits.

The MPS callback procedure 154 operates in the background with the operating system 110 to protect access to regions of the memory 130 allocated to processes and has little impact on performance of applications operating on or usability of the computer system 100. Further, minimal intervention is required on the part of the user to enable such protection other than activating the MPS 114.

It should be apparent to those who have skill in the art that any combination of hardware and/or software may be used to implement components of the MPS 114 described herein. It will be understood and appreciated that one or more of the processes, sub-processes, and process steps described in connection with FIGS. 1-9 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 1-9. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module, a process, or controller (e.g., the MPS control process 150, the MPS user interface process 152, and the MPS callback procedure 154), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the present embodiment comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A system for controlling access by a requesting process to a region of memory associated with a target process operating on a computer-based device, comprising:
a procedure having executable instructions that causes the computer-based device to:
intercept a request for a reference to the region of memory from the requesting process;
receive the reference;
determine if the requesting process is authorized to access the region of memory;
provide the received reference to the requesting process if the requesting process is authorized; and
develop a modified reference and provide the modified reference to the requesting process instead of the received reference if the requesting process is not authorized, wherein the modified reference prevents the requesting process from accessing the region.

2. The system of claim 1, wherein the procedure causes the computer-based device to determine whether the target process is a protected process, develop the modified reference only if the target process is a protected process, and provide the received reference to the requesting process otherwise.

3. The system of claim 2, further comprising one or more configuration files that specify whether the requesting process is authorized and the target process is protected.

4. The system of claim 3, wherein the one or more configuration file(s) identifies an application program that is protected and the procedure causes the computer to determine the target process is associated with the application program.

5. The system of 4, wherein the one or more configuration file(s) is user-modifiable to specify a further application program that is protected.

6. The system of claim 1, wherein the procedure causes the computer-based device to develop the modified reference by modifying an access permission encoded in the reference.

7. The system of claim 1, wherein the procedure causes the computer-based device to always provide the received reference to the requesting process if the requesting process and the target process are determined to be associated an identical application program.

8. The system of claim 1, wherein the procedure causes the computer-based device to develop a first fully resolved file path of an application program associated with the requesting process, a second fully resolved file path of an application program associated with the target process, and compare the first fully resolved file path and the second fully resolved file path to determine if the requesting process and the target process are associated with the identical application program.

9. The system of claim 1, further including a control process having executable instructions configured to cause the computer-based device to selectively install and deinstall the procedure as a kernel-level driver.

10. A method for controlling access by a requesting process to a region of memory associated with a target process, comprising:
intercepting an operating system request for a reference to the region of memory from a requesting process;
receiving the reference;
determining if the requesting process is an authorized process allowed access to the region of memory;
providing the received reference to the requesting process if the requesting process is authorized; and
developing a modified reference and providing the modified reference instead of the received reference to the requesting process if the requesting process is not authorized, wherein the modified reference prevents the requesting process from accessing the region.

11. The method of claim 10, further including determining whether the target process is a protected process, developing the modified reference only if the target process is a protected process, and providing the received reference to the requesting process otherwise.

12. The method of claim 11, further using one or more configuration files to specify the requesting process is an authorized process and the target process is a protected process.

13. The method of claim 12, wherein the one or more configuration file(s) identifies an application program that is protected and determining the target process is a protected process if the target process is associated with the application program.

14. The method of claim 13, further including modifying the one or more configuration file(s) to specify a further application program that is protected.

15. The method of claim 10, wherein developing the modified reference comprises modifying an access permission encoded in the reference.

16. The method of claim 10, further including always providing the received reference to the requesting process if the requesting process and the target process are determined to be associated an identical application program.

17. The method of claim 10, further including developing a first fully resolved file path of an application program associated with the requesting process and a second fully resolved file path of an application program associated with the target process, and comparing the first fully resolved file path and the second fully resolved file path to determine if the requesting process and the target process are associated with the identical application program.

18. The method of claim 10, further including selectively installing and deinstalling a kernel-level driver that undertakes the steps of the method.
